(19) United States
(12) Patent Application Publication
(10) Pub. No.: US 2001/0010768 A1
(43) Pub. Date: Aug. 2, 2001

(54) Electrostatic recording method and electrostatic recording apparatus

(76) Inventors: Yuji Furuya, Ibaraki (JP); Hiroyoshi Matsumoto, Ibaraki (JP)

Correspondence Address: SUGHRUE, MION, ZINN, MACPEAK & SEAS, PLLC, 2100 Pennsylvania Avenue, N.W., Washington, DC, 20037-3202, US

(21) Appl. No.: 09/760,657

(22) Filed: Jan. 17, 2001

(30) Foreign Application Priority Data
Jan. 21, 2000 (JP) P. 2000-012914
Feb. 25, 2000 (JP) P. 2000-049070

(51) Int. Cl. G03G 15/16

(52) U.S. Cl. 399/296

(57) ABSTRACT

Prior to the transfer process, the pre-transfer charging is conducted on the recording image formed on the electrostatic recording body by the development process, and the potential difference generated in the air gap between the recording medium and the recording image at the time of transfer, is made smaller than the Paschen discharge potential difference.

### BACKGROUND OF THE INVENTION

1. Field of the Invention

The present invention relates to an electrostatic recording method appropriate for obtaining a highly fine recording image, and to an electrostatic recording apparatus.

2. Description of the Related Art

A digital printing machine which is known as a form of the electrostatic recording apparatus has an advantage exceeding the conventional printing method, and as being represented by on-demand-publishing, a high speed and high resolusion printing method is investigated.

Also in the electronic photographing method which is representative as the recording method used in the electrostatic recording apparatus, in order to attain these requirements, covering over the optical system, electrostatic recording body (for example, dielectric body, or photoreceptor), development engineering, electrostatic transfer engineering, heating-pressure-fixing engineering, and cleaning system, a series of improvements are advanced.

Then, as the result of a series of improvements, although the recording image formed on the electrostatic recording body (for example, the toner image) satisfies a predetermined relationship to the latent image formed on the electrostatic recording body in both of the size and the shape, and realizes the high resolusion printing, the disturbance is generated in the size and shape of the toner image at the time of the electrostatic transferring, and this is recognized as the factor to prevent the high resolusion printing.

As the cause, it is considered that, in the process in which the recording medium holding the toner image (mainly the recording sheet) is separated from the electrostatic recording body, because the both are in the high voltage charging condition, when the separation discharging, that is, when the voltage larger than the predetermined voltage is applied on the air layer of the gap, so called the Paschen discharge following the ionization of the air layer is generated, and the impulsive large current at this time disturbs the toner image.

Accordingly, in the conventional technology, the structure in which the AC discharging is conducted on the stage after the transferring and before the separation, is known. However, in order to apply the above structure to the high speed printing, it is necessary that the recording medium and the electrostatic recording body are brought into contact with each other under the flat condition, or when the electrostatic recording body is the drum-shape, the recording medium is wound around the outer periphery of the electrostatic recording body by a predetermined length, and the contact surface is increased, and the discharging means is provided in the contact condition.

However, when the contact surface of the recording medium with the electrostatic recording body is increased, it is difficult to keep the running speed of the recording medium and the electrostatic recording body at the same speed, and according to the relative speed difference, another problem in which the disturbance of the printing image is generated due to the difference of the relative speed, is generated.

Further, in the structure in which the recording medium and the electrostatic recording body are brought into contact with each other under the flat condition, the electrostatic recording body is used, for example, as a thin seamless photoreceptor belt, however, the generation of the extension and contraction due to the change of temperature or humidity of the belt material, or elongation or sagging in the use for the long period of time, is the problem to be overcome in the high speed printing.

Because, in the rigidity strength and deformation, it can have the durability, in the high speed printing, the use of the photoreceptor drum is preferable, and considering the generation of the speed defference between the recording medium and the photoreceptor drum, in the contact of the recording medium and the photoreceptor drum, it is considered that the line contact is preferable from the viewpoint of the mechanical accuracy. However, when the electrostatic recording body is the photoreceptor drum, the actual condition is that the pre-separation AC discharging just after the transferring is difficult from the viewpoint of the apparatus structure.

From above description, in the separation process after the transfer, although the electrostatic recording body is the photoreceptor drum or photoreceptor belt, it is a problem of the high resolusion printing to realize the lowering of the voltage of the recording medium and the electrostatic recording body, and no-charging condition of them. Returning to the potential formation situation in each of processes of the electrostatic latent image formation, development, and transfer of the electrophotographic electrostatic recording method, this problem will be described.

In the electrophotographic recording method, ordinary, in the dark portion, the photoreceptor surface which is the electrostatic recording body, is charged to the initial voltage V0 of several hundred volts to several thousand volts in the positive or negative polarity, next, the image-wise exposure is conducted on the charged photoreceptor, and the potential Va of a portion on which the light is irradiated, is lowered to about ±several ten volts, and the portion on which the light is irradiated, and a portion on which the light is not irradiated, on the photoreceptor surface, are discriminated in the conspicuous potential difference and formed as the electrostatic latent image, and the development as the visualization of the electrostatic latent image, is conducted. In this connection, the development method is largely divided into the reversal development system and the normal development system.

Herein, when a case where a negatively charged organic photoreceptor is used as the photoreceptor, and the reversal development system in which the negatively charged toner is used, is adopted as the development system, is considered as the presupposition, the light irradiation portion Va forms the image portion potential, the toner particle is accumulated on the light irradiation portion Va, and forms the recording image, and the toner image does not adhere onto the area of the initial potential V0, and the area is expressed as the background portion.

Further, in the development process, generally, development bias potential Vb is impressed, and the ideal development condition is that the surface potential Vr of the toner image developed on the image portion of the electrostatic recording body is equal to the development bias potential Vb (Vr=Vb), however, in the condition after the development of the negatively charged photoreceptor, reversal development system, and the electrophotographic recording method using the negatively charged toner, generally, the relationship of V0<Vb<Vr<Va≧0, is shown, and when it is rewritten as the absolute value, in the case of the reversal development system, the relationship is 0≧|Va|<|Vr|<|Vb|<|V0|.

The toner image formed on the photoreceptor in the development process is transferred next onto the sheet by the transfer device. On the transfer electrode of the transfer device, the voltage Vt with the reversal polarity to the charging polarity of the toner particle is impressed, and the toner image on the photoreceptor is electrostatically attracted onto the sheet side by the electrostatic attraction force. Therefore, the voltage difference (Vt−Va) between the transfer voltage Vt and the light irradiation portion potential of the electrostatic latent image (the image portion potential) Va is smaller than the potential difference (Vt−V0) between the transfer voltage Vt and the initial potential (the background portion potential) V0 (|Vt−Va|<|Vt−V0|).

On the one hand, when the normal development system is used, in reverse to the above reversal development system, the potential V0 of the portion onto which the light is not irradiated, is the image portion potential, and onto the image portion potential area, the toner with the reversal polarity to the potential V0 adheres, and is developed and the recording image is formed, and the toner does not adhere onto the potential Va portion onto which the light is irradiated, and the portion forms the background portion.

Accordingly, the relationship of each potential in the case of the normal development system is, when it is expressed by the absolute value, 0≧|Va|<|Vb|<|Vr|<|V0|, and when this is compared to the case of the above reversal development method, the relationship of the development bias potential Vb and the surface potential Vr of the toner image is replaced with each other.

Further, because the toner particle is the reverse polarity to the electrostatic latent image, the transfer voltage Vt is the same polarity as the electrostatic latent image, and the potential difference (Vt−V0) between the potential of the image portion V0 of the electrostatic latent image formed on the photoreceptor and the transfer voltage Vt is a smaller value than the potential difference (Vt−Va) between the transfer voltage Vt and the background portion potential Va (|Vt−V0|<|Vt−Va|).

According to the above description, irrespective of the reversal development system and the normal development system, it is important that the potential difference between the transfer voltage Vt and the image portion potential on the photoreceptor is smaller than the potential difference between the transfer voltage Vt and the background portion potential on the photoreceptor.

The electrostatic transfer process when the negative charged photoreceptor is used as the photoreceptor, and the reversal development system using the negative charged toner is adopted as the development system, will be further considered. Herein, because the transfer voltage Vt is required to give the electrostatic attractive force onto the negatively charged toner, the transfer voltage Vt is the positively charged voltage with the sign reverse to the initial potential of the photoreceptor. When the positively charged transfer voltage Vt is impressed, the local minimum value of the potential appears in the spatial potential distribution of the toner layer, and the porality of electric field acting on the toner layer, that is, each direction of the electrostatic force is reversed on the boundary of the local minimum value of the toner layer potential distribution. As the result, the toner layer is separated to the photoreceptor side and the sheet side, and a part of it is transferred onto the sheet, and the remained portion is not transferred onto the sheet, and remains on the photoreceptor.

In the transfer process, the spatial gap width formed by the photoreceptor, toner layer, and sheet, is constant, and it is considered that the separation process of the toner layer under the action of the electrostatic field is generated by the compression of the toner layer. In the toner layer to form the recording image, separated to the sheet side and the photoreceptor side, both the average electric charge density and the potential are equal to each other, and accordingly, it is considered that the potential difference A Vr of the gap air layer generated in the compression and separation process of the toner layer, in the electrostatic transfer process of the toner layer to form the electrostatic recording image, that is, under the action of the electrostatic force, is almost 0 volt.

On the one hand, in the transfer process, in the background portion potential area on the photoreceptor, because the toner layer is formed on the peripheral portion, a gap corresponding to the thickness of the toner layer is formed between the background portion potential area and the sheet. Accordingly, an air layer corresponding to the thickness of the toner layer is generated. Herein, the background portion potential V0 on the photoreceptor is also corrected by the layer formation, however, nevertheless, the potential difference ΔVw of the gap air layer formed between the sheet and the background portion potential area on the photoreceptor has large value because the transfer voltage Vt is the positive charge.

Accordingly, when the potential difference ΔVr of the gap air layer generated in the toner layer according to the spatial compression, separation in the transfer process, is compared to the potential difference ΔVw of the gap air layer formed by the sheet and the background portion potential area, then, ΔVr<<ΔVw.

Herein, further, the separation process of the photoreceptor just after the electrostatic transfer and the sheet onto which the toner image is transferred, is considered. When the above ΔVr, and ΔVw are regarded as the potential difference of the capacitor formed of respective gap air layers, the relationship of the electrostatic capacity C, potential difference ΔV, and effective electric charge Q, is ΔV=Q/C, and it can be considered that the electric charge just after the transfer is small and a constant value, even when the time change is generated.

When the effective electric charge of the gap air layer of the toner layer compressed and separated as described above, is Qr, the gap air layer is dr₀, the area of the corresponding portion is Sr, the effective electric charge of the gap air layer of the background portion potential area is Qw, the gap air layer is d_{W0}, the area of the corresponding portion is Sw, and the dielectric constant of the air is ε₀, then

ΔVr=Qr·dr₀/Sr·ε₀ (1)

ΔVw=Qw·dw₀/Sw·ε₀ (2)

Herein, when the effective electric charge surface density of the toner layer is qr=Qr/Sr, and the effective electric charge surface density of the background portion is qw=Qw/Sw, then

ΔVr=qr·dr₀/ε₀ (3)

ΔVw=qw·dw₀/ε₀ (4)

It is supposed that, according to the separation process of the photoreceptor and the sheet, each gap air layer enlarges in the time base, in the form of

dr(t)=dr₀+kt (5)

dw(t)=dw₀+kt (6)

And each gap air layer enters into the separation process. Herein, k is a separation speed coefficient of k>0. Accordingly, in the separation process of the photoreceptor just after the transfer and the sheet including the toner layer, when the separation start time is t=0, the potential difference of the gap air layer is

ΔVr(t)=(qr/ε₀)·(dr₀+kt) (7)

ΔVw(t)=(qw/ε₀)·(dw₀+kt) (8)

Herein, the gap air layer is given by the relational expressions (5) and (6), and although these do not necessarily express the geometrical separation condition after the line contact of the photoreceptor drum and the flat sheet, the important point is that, irrespective of relational expressions, the time change portion of the gap air layer shows the same time change in both of the image portion area and the background portion area. Accordingly, ΔVr(t) and ΔVw(t) change to the large potential difference while keeping the relationship of ΔVr<<ΔVw.

The Paschen discharge is the ionization discharge breakdown phenomenon of the air generated when the voltage more than a predetermined value is impressed upon the gap air layer, and because ΔVr(t)<<ΔVw(t), it is concentrated to the background portion rather than the image portion, however, because the toner is not adhered onto the background portion, even when the Paschen discharge occurs, it has no relationship with the toner image itself, and relating to the influence of the Paschen discharge in the electrostatic transfer process onto the toner image, it can be concluded from the above consideration that the peripheral contour portion of the toner image which is a boundary between the toner image and the background portion, is more strongly influenced. In facts, when the toner image on the photoreceptor after the development and before the transfer is compared to the toner image on the sheet after the transfer, it is found that the print failure in the electrostatic transfer is concentrated on the peripheral contour portion of the toner image, and it is generated irrespective of the large and small of the transfer voltage Vt. Further, when the solid image of several cm² is investigated, for example, even when the density is thin, the transfer blur is concentrated on the peripheral contour portion of the solid image, and it can be considered that the above consideration is proved.

The above consideration is also effected for any combination of the normal development system/reversal development system, or the positive charge photoreceptor/negative charge photoreceptor, and the Paschen discharge is generated being concentrated on the background portion rather than the image portion on which the toner layer on the photoreceptor is accumulated, under the condition of ΔVr<<ΔVw, therefore, it can be concluded that the peripheral contour portion of the toner image forming the boundary area between the background portion and the image portion, is mainly influenced, and the blur of the toner image and the image distortion phenomenon are generated.

### SUMMARY OF INVENTION

The object of the present invention is to provide an electrostatic recording method and an electrostatic recording apparatus, by which the Paschen discharge generated in the separation process of the recording medium and the electrostatic recording body can be prevented, and the generation of the transfer blur and the print disarrangement can be prevented.

The above object can be attained by the following method: an electrostatic recording method, which comprises; an electrostatic latent image forming process for forming an electrostatic latent image having the image portion potential and the background portion potential on an electrostatic recording body; a developing process for supplying recording agents onto the electrostatic recording body holding the electrostatic latent image, and for visualizing an area of the image portion potential as a recording image; and a transfer process for transferring the recording image formed on the electrostatic recording body onto a recording medium, the electrostatic recording method is characterized in that: prior to the transfer process, the pre-transfer charging is conducted on the recording image formed on the electrostatic recording body by the developing process; and the potential difference generated in an air gap between the recording medium and the recording image is made smaller than the Paschen discharging potential difference.

Further, it is attained by an electrostatic recording apparatus, which comprises: an electrostatic latent image forming means for forming an electrostatic latent image having the image portion potential and a background portion potential on a electrostatic recording body; a developing means for supplying recording agents onto the electrostatic recording body holding the electrostatic latent image, and for visualizing an area of the image portion potential as a recording image; and a transfer means for transferring the recording image formed on the electrostatic recording body onto a recording medium, in which the electrostatic recording apparatus has: an ion generation means for supplying the ion with the predetermined polarity to the electrostatic recording body, which is arranged between the developing means and the transfer means; and a grid electrode means, which is arranged between the electrostatic recording body and the ion generation means and has the grid potential set to the potential between the image portion potential and the background portion potential, for controlling the movement of the ion so that at least the background portion potential in the surface potential of the recording image and the background portion potential, becomes equal to the grid potential.

In the above Paschen discharge resolving means, the relationship of the potential on the photoreceptor after the development and before the transfer, that is the initial potential, the image portion latent image potential, the background portion potential, and the surface potential of the toner image after the development, is the basis of the present invention, therefore, it will be detailed by using the Poisson equation expressing the electrostatic potential distribution. In this connection, the description herein is according to the reversal development system.

The two-component dry type developing agent composed of the toner particles and the carrier particles is stirred in the development device, and the characteristic charging amount (q/m) of the toner is determined. The developing agent passes through the doctor gap of the gap G, and the thickness of the developing agent is regulated, and the developing agent becomes closed pack (thick accumulation) condition. The thickness of the development nip area is set to almost equal value to the doctor gap. In the development nip area, the developing agent which is initially electrically neutral in the whole is, by the action of the development bias potential Vb, subjected to the electrostatic force (±q(Vb−Va)/G) between the image portion potential Va and it, and the toner particle oozes from the developing agent layer, is separated from it, supplied to the image portion potential Va, and forms the toner image. At this time, the toner particle exerts the repulsive force on each other among the same kind of electric charges, and makes the sparsely distributed toner layer, therefore, the volume density of charge pt of the toner layer after separation can be written as ρt=(q/m)ρtg·P. Herein, ρtg is the density of the toner, P is a packing ratio (volume bulk density). The developing agent after the toner particle is separated, has the electric charge amount per unit time equal to the electric charge amount which is brought out by the separation toner particle in the time base. When the thickness of the toner layer formed in the development process is d₂, and the thickness of the developing agent after the toner layer formation is d₃, then, because the toner charge density ρt, and the electric charge density of the carrier ρc of the developing agent are equal charge amount with the different sign, to the volume passing through the development nip in a unit time, when the peripheral speed of the photoreceptor is vr, and the peripheral speed of the development magnetic roller in the development device is vm, then, the following relationship is obtained:

ρt·vr·d₂+ρC·vm·d₃=0 (9)

(∴ρc=−ρt·d₂/h·d₃, h=vm/vr). Herein, h is the ratio of the peripheral speed of the photoreceptor and the development magnetic roller. In the development nip area, under the impression of the development bias voltage Vb, this process advances, and the three layers of the photoreceptor (potential Va), toner layer (electric charge density pt), and developing agent layer (electric charge density pc)are formed. When the Poisson equation is solved under this condition, the potential distribution φ(x) of the toner layer is as follows:

φ(x)=Vb−(ρt/2ε₂)(x−x₂)²+(ρc/2ε₂)(x−x₂)d₃+(J/ε₂)(x−x₂)−JD₃ (10)

Where, J=(1/ΣD)(Vb−Va−ρtd₂(D₁+D₂/2)−ρc(d₃/2)(D₁+D₂)) (11)

Herein, ΣD=(D₁+D₂+D₃), D₁ is the dielectric thickness of the photoreceptor (D₁=(d₁/ε₁)), D₂ is the dielectric thickness of the toner layer (D₂=(d₂/2)), and D₃is the dielectric thickness of the developing agent layer (D₃=(d₃/3)). Further, x₁=d₁, x₂=d₁+d₂, x₃=d₁+d₂+d₃. The potential distribution of the toner layer of the equation (10) has the extremal value to the position x, then,

dφ(x)/dx=−(ρt/ε₂)(x−x₂)+(ρc/2ε₂)d₃+(J/ε₂) (12)

When dφ(x)/dx|x₂=0, at x=x₂ position, the potential is the minimum value, and the electrostatic force exerting on the toner layer in the range of x≧x2 goes to the photoreceptor. That is, in the development nip area, the whole area of the toner layer separated from the developing agent in the development nip area is developed, and accumulated onto the photoreceptor, and becomes the condition under which the toner image is formed.

dφ(x)/dx|x₂=(ρc/2ε₂)d₃+(J/ε₂)=0

∴J=−ρcd₃/2=ρtd₂/2h (13).

In the case where the expression (13) is realized, when the potential of the toner layer is φ*,

The photoreceptor and the toner layer interface:

φ*(x₁)=Va+ρt·d₂D₁ (14)

Toner layer surface:

φ*(x₂)=Vb−ρtd₂D₃/2h (15)

=Va+ρt·d₂(D₁+D₂/2) (16).

When the electrostatic recording body is an organic photoreceptor, and the initial potential V₀=−650 V, the image portion (light irradiation portion) potential Va=−100 V, the development bias potential Vb=−400 V, and the electric charge density of the reversal development toner ρt<0, then, the toner layer surface potential on the image portion of the electrostatic recording body is, from the relational expression (15), under the ideal condition of the peripheral speed ratio h=∞, φ*(x₂)=Vb, and from the relational expression (16), it is found to be on the surface potential of Vb≧φ*(x₂)<Va≧0.

On the one hand, because V₀<V_{b}<0, ρt<0, the toner particle is not accumulated on the background portion (non light irradiation portion), and the surface potential of this portion is scarcely changed as the potential of V₀ is. When the surface potential of the toner image formed on the photoreceptor is Vr, Vr=φ*(x₂), and as the potential after the development and before the transfer, the relationship of V₀<Vb<Vr<Va≧0 is realized. In the reversal development system, when the transfer voltage Vt>0 is impressed, Vt−V₀>Vt−Vr, and to the above expressions (1) and (2), ΔVr≧ΔVw is realized.

From the above consideration, in the reversal development system, in order to prevent the Paschen discharge of the peripheral contour portion of the toner image, it is found to be preferable that, at the time point before the transfer, the absolute value of the background portion potential V₀ of the photoreceptor is selectively lowered to the voltage value near 0 volt.

### BRIEF DESCRIPTION OF THE DRAWINGS

FIG. 1 is an outline structural view of an electrostatic recording apparatus of the present invention.

FIG. 2 is a conceptual view of main portions of the present invention.

FIGS. 3A and 3A1 to 3B4 are illustrations each showing the relationship between each potential and an ion movement in the case of a reversal development system by the negative charge of the photoreceptor.

FIGS. 4A and 4B1 to 4B2 are illustrations each showing the relationship between each potential and an ion movement in the case of the reversal development system by the positive charge of the photoreceptor.

FIGS. 5A and 5B1 to 5B2 are illustrations showing the relationship between each potential and an ion movement in the case of a normal development system by the negative charge of the photoreceptor.

FIGS. 6A and 6B1 to 6B2 are illustrations each showing the relationship between each potential and an ion movement in the case of the normal development system by the positive charge of the photoreceptor.

FIG. 7 is atypical view showing the one dimensional 5-layer model for explaining the transfer mechanism of the electrostatic image.

FIG. 8 is an illustration showing the relationship between the transfer efficiency and the transfer voltage.

FIG. 9 is an illustration showing the relationship between the local minimum value of the toner layer potential distribution and the transfer voltage.

FIG. 10 is an illustration showing the relationship between the toner layer potential distribution and the transfer voltage.

### THE DETAILED DESCRIPTION OF THE PRESENT INVENTION

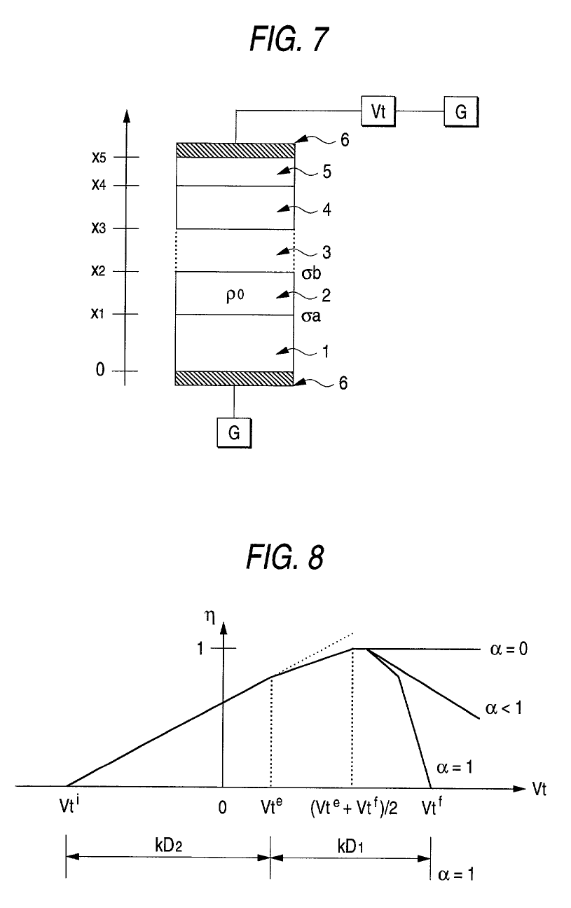

An embodiment of the present invention will be described below. Initially, referring to FIG. 7 to FIG. 10, an electrostatic recording method according to the first to the sixth aspect of the invention will be detailed.

In order to make the transfer mechanism clear, 5-layer model shown in FIG. 7 will be adopted herein.

The first layer (1) is an electrostatic recording body layer whose rear surface is electrically grounded (mainly electrophotographic photoreceptor), and the thickness d₁, dielectric constant ε₁, and dielectric thickness D₁=d₁/ε₁. Herein, as the developing method, the reversal developing method is adopted, and as the initial surface potential is V₀, the potential of an area which is developed by the recording agent (toner) is Va, it will be described below. In this case, the relationship of the potential of each area and the surface electric charge density can be given by V₀=σD₁, Va=σaD₁.

The second layer (2) is the toner layer after the development, and the thickness d₂, dielectric constant ε2, and dielectric thickness D₂ . This toner layer has the electric charge designated by the volume density of charge σ₀, on the condition after the development and before the transfer, and further, as the pre-transfer charging, the electric charge with the surface density of electric charge σb can be given onto the surface. Herein, because the reversal development is adopted, the relationship of the polarity of ρ₀·Va=ρ₀·σaD₁>0 is realized.

The third layer(3) is the gap air layer, and the thickness d₃, dielectric constant ε₃ (=ε₀ (the dielectric constant of the vacuum)), and dielectric thickness D₃ In the transfer, even when the recording medium (sheet) and the toner layer are in close contact with each other, it is considered from the undulation of the sheet surface that microscopically, about below 10 μm air gap layer accompanies that.

The fourth layer (4) is the recording medium layer, and the thickness d₄, dielectric constant ε₄, and dielectric thickness D₄.

The fifth layer(5) is the transfer auxiliary body layer formed of rubber or polymeric materials, and is, generally, belt or roller-shaped, and the surface or core material is set to the transfer potential Vt as the transfer electrode. Normally, the relationship of the electric charge of the toner layer and Vt is ρ0·Vt<0 so that the electrostatic attractive force can exert, however, as considered hereinafter, the present invention is not specifically limited to this relationship. The impression method of the transfer voltage Vt may also be possible either in the case where the high power source voltage is directly connected to the conductive core material, or in the case where, in the corona voltage impression, the voltage is specified as the surface potential of the fifth layer. The following is defined herein: the thickness of this layer is d₅, dielectric constant is ε₅, and dielectric thickness is D₅.

The coordinate of the position of each layer is expressed by x, and the origin of the coordinates is defined as the electric ground interface of the first layer. In this designation method, for example, the surface position of the second layer (2) is given as x₂=d₁+d₂. To the above setting, the Poission linear simultaneous differential equation is solved, and considering the continuity of potential of each interface and the boundary condition of the electric flux density, the potential of each position is given. The obtained potential is written by Φ(x)

The first layer:

Φ₁(x)=(x/ε₁)(H₀+σa+σb+ρ₀d₂) (17)

The second layer:

Φ₂(x)=Vt−(ρ₀/2ε₂)(x−x₂)+((x−x₂)/2)(H₀+σb)−H₀(D₃+D₄+D₅) (18)

The third layer:

Φ₃(x)=Vt+(H₀/ε₃)(x−x₃)−H₀(D₄+D₅) (19)

The fourth layer:

Φ₄(x)=Vt+(H₀/ε₄)(x−x₄)−H₀D₅ (20)

The fifth layer:

Φ₅(x)=Vt+(H₀/ε₅)(x−x₅) (21)

where,

H₀=(ΣD)⁻¹(Vt−Va−ρ₀d₂(D₁+D₂/2)−σb(D₁+D₂)),

ΣD=D₁+D₂+D₃+D₄+D₅.

From these results, it is characterized that the term of H₀ commonly appears in the potential distribution of each layer, and in H₀, the terms of the transfer voltage Vt of external impression, the potential Va of the photoreceptor electrostatic recording body layer of the development area, and the pre-transfer charging added onto the toner layer surface σb(D₁+D₂) and ρ₀d₂(D₁+D₂/2), are included, however, the origin of the term of ρ₀d₂(D₁+D₂/2) is not always clear.

Accordingly, in this 5-layer model, 2-layer model of D₃=D₄=D₅=0 is adopted, and the pre-transfer charge amount σb=0, Vt=Vb (development bias potential), are put, and the situation of the photoreceptor adhesion toner layer during the development, or just after the development will be considered. The potential of the 2-layer condition can be expressed by the following relational expression by using Φ(x).

The first layer:

Φ₁(x)=(x/ε₁(D₁+D₂))(Vb+σaD₂+(ρ₀d₂D₂)/2) (22)

The second layer:

Φ₂(x)=Vb−(ρ₀/2ε₂)(x−x₂)²+((x−x₂)/ε₂ (D₁+D₂))(Vb−Va−ρ₀d₂(D₁+D₂/2)) (23)

Herein, when the expression (23) is differentiated by x, and the extremal value is X₀,

dΦ₂(x)/dx=−ρ₀(x₀−x₂)/ρ₂+(Vb−Va−ρ₀d₂(D₁+D₂/2))/ε₂(D₁+D2)

=0 (24)

In this model, when the electrostatic recording body layer is an organic photoreceptor (OPC), and because, normally, V₀<0, Va<0, and because it is the reversal development, ρ₀<0, the extremal value in the expression (23) is the local minimum value, and it can be known that the toner layer is subjected to the force to the development bias side in x>x₀ on the boundary of the local minimum value, and in x<x₀, to the photoreceptor side, that is, the spontaneous separation of the toner layer just after the development can be known. Accordingly, the height (thickness) of the toner layer surface is given by the following expression when the boundary value is defined as x₀=x₂.

Vb−Va=ρ₀d₂(D₁+D₂/2) (25)

In this expression, when the development is conducted under the condition of the photoreceptor surface potential Va, and the development bias potential Vb, the potential difference between developed toner layers is given as ρ₀d₂(D₁+D₂/2), and when the ρ₀ is determined, this becomes the relational expression giving the toner layer thickness d₂(D₂) Of course, from the selection of the development conditions, for example, depending on the enlargement of the development gap, there is also a case in which the development is not conducted, therefore, the expression (25)can be considered as an ideal condition. Herein, the volume density of electric charge ρ₀ is given by the following expression with respect to the specific electric charge of the toner (Q/M), the weight density ρg, and the volume bulk density P:

ρ₀=(Q/M)ρgP (26).

Ordinarily, in the development condition of the electrophotography, the development material is developed through the micro development gap, and in the process after the development to the transfer, it is released from the micro development gap area. That is, while it is subjected to the strong compression force during the development, until it comes to the transfer after that, it is under the released condition of the compression force. Accordingly, because the volume bulk density P can be changed, further, considering about the separation from the ideal condition, the expression (25) is re-written to the expression (27), and θ is defined as the development efficiency, and Vd is the surface potential of the toner layer.

Vd−Va=θ(Vb−Va)=ρ₀d₂(D₁+D₂/2) (27)

From the expression (27), the toner layer thickness d₂ is given as follows in the form of the dielectric thickness D₂(=d₂/ε₂)

D₂=D₁((1+(2θ(Vb−Va)/ρ₀ε₂D₁²))^{½}−1) (28)

From the relationship of the 2-layer model, in the electrophotographic recording method, ρ₀d₂ (D₁+D₂/2), that is, Vb, Vaρ₀, ε2, and D1 is closely and inseparably combined with each other, and from these relationships, the toner layer d₂ is given, and these form the initial conditions and it is shown that the processing advances to the transfer process. Herein, in addition to the above condition setting, the pre-transfer charging after the development σb is impressed on the toner layer surface, and the transfer process will be considered again by using the 5-layer model.

The potential difference between layers of the toner layer is (Φ2(x2)−Φ1(x1), and from the consideration of the 2-layer model, this is written to ρ1d2(D1+D2/2), and ρ1 is considered that it is the volume density of electric charge of the primary correction of the toner layer corrected by the transfer potential Vt, and the pre-transfer charge σb.

Φ₂(x₂)−Φ₁(x₁)=ρ₀d₂(D₁+D2/2)−ρ₀d₂(D₁+γD₂)+(D₂/ΣD)(Vt−Va+σb(D₃+D₄+D₅))

=ρ₁d₂(D₁+D₂/2)

∴ρ₁=ρ₀−ρ₀(D₁+γD₂)/(γΣD)+(Vt−Va+σb(D₃+D₄+D₅))/(ε₂γ(ΣD)²) (29)

where γ=(D₁+D₂/2)/ΣD.

To the primary correction electric charge density of the expression (29), ρ₀ in the expression (21) is changed to Σ₁ from the expression (17), and the potential of each area can be obtained in the same manner as Φ₁(1), Φ₂(1), . . . Φ₅(1). By using this primary correction potential expression, the secondary, tertiary, . . . , the k-degree correction electric charge density can be repeatedly obtained. This operation shows a method in which, when the external voltage Vt is impressed, and the voltage of the toner layer is changed, the change of the electric charge of the toner layer and the voltage following that is operated self-indifferently, and the convergence value becomes the satisfactory solution. To write the calculation simply,

a=(D₁+γD₂)/(γΣD); and

b=(Vt−Va+σb(D₃+D₄+D₅))/(ε₂γ(ΣD)²) (30),

are respectively replaced, the above expressions can be re-written as follows.

ρ₁=ρ₀(1−a)+b

ρ₂=ρ₀(1−a)²+b+b(1−a)

ρ₃=ρ₀(1−a)³+b(1+(1−a)+(1−a)²)

ρₖ(1−a)^{k}+bΣ(1−a)^{k-1}

This electric charge correction expression converges to |1−a|<1. This corresponds to 0<a<2, and because 2−a==(D1+(1−γ)D2)/(γΣD)>0, it is found that the converging condition is satisfied. The converging value is expressed as ρₙ, when, to k→∞, bΣ(1−a)^{k-1}=(b/a) is used (ρₙ=(Vt−Va+σb(D₃+D₄+D₅)/ε₂(D₁+γD₂)ΣD))

As described above, obtained ρ₀, ρ₁, . . . ρₖ and converging value ρₙ give the solution from the superposition principle of the solution of the differential equation, and the linear combination of them also gives the solution. Accordingly, the linear combination of the initial value ρ₀ and the converging value ρₙ is obtained in the following form, and is made to the volume density of electric charge ρₜ of the toner layer corrected by Vt and σb. In this expression, in the transfer process, because ρ₀ and Vt normally have the relationship of the different sign with each other, the coefficient α of the linear combination is considered as the sign reversal efficiency of the toner layer electric charge.

ρₜ=ρ₀+αρn

=ρ₀+α(Vt−Va+ρb(D₃+D₄+D₅))/(ε₂(D₁+γD₂)ΣD) (31)

Because the volume density of electric charge of the toner layer is made ρₜ, the potential of each area has also a corrected form, and these are expressed as ψ(x), and the above H₀ is also re-written as Hₜ.

The first layer:

ψ₁(x)=(x/ε1)(Hₜ+σa+σb+σₜd₂) (32)

The second layer:

ψ₂(x)=Vt−(ρt/2ε₂)(x−x₂)²+((x−x₂)/ε₂)(Hₜ+σb)−Hₜ(D₃+D₄+D₅) (33)

The third layer:

ψ₃(x)=Vt+(Hₜ/ε₃)(x−x₃)−Hₜ(D₄+D₅) (34)

The fourth layer:

ψ₄(x)=Vt+(Hₜ/ε₄)(x−x₄)−HₜD₅ (35)

The fifth layer:

ψ₅(x)=Vt+(Hₜ/ε₅)(x−x₅) (36)

where

Ht=(ΣD)⁻¹(Vt−Va−ρₜd₂(D₁+D₂/2)−σb(D₁+D₂) =(ΣD)⁻¹(Vt−Va+σb(D₃+D₄+D₅))−ρₜd₂γ−σb=(ΣD)⁻¹(Vt−Va+σb(D₃+D₄+D₅)) (B/A)−ρ₀d₂γ− σb (37)

Herein, in order to simplify the expression, the relationships of A=D₁+γD₂, B=D₁+γD₂(1-α), C=D₁+D₂(γ+α(1−γ)), A−B=αγD₂, C−B=αD₂, C=A+α(1−γ))D₂, are used.

From the same discussion as in the 2-layer model after the above expression (24), the extremal value x₀ of the potential distribution of the toner layer is obtained. When the expression (33) is differentiated,

dψ₂/dx=ρₜ(x₀−x₂)/ε₂+(Hₜ+σb)/ε₂=0 (38).

Herein, the toner layer of x>x₀ is exerted by the force to the recording medium side which is the transfer material, and the toner layer of x<x₀ is exerted by the force to the photoreceptor side which is the electrostatic recording layer. Accordingly, the toner layer of x>x₀ is transferred onto the recording transfer material, and x<x₀ remains on the photoreceptor. Because the thickness of the toner layer before entering into the transfer position is d₂, the transfer efficiency η of the ideal form can be expressed by the following expression.

η=(x₂x₀)/d₂=−(Hₜ+σb)/σₜd₂ (39)

From this expression, the transfer start condition is given by the transfer voltage vt=Vt¹, which gives x₀=x₂. On the one hand, the transfer end condition is η=1, and accordingly, the transfer voltage Vt to give x₀=x₁ can be specified as Vt=Vt^{e}. In the expression (38), when x₀=x₂, Vt=Vtⁱ, then, the transfer start voltage vtⁱ is, Ht+σb=0,

∴Vti=Va−σb(D₃+D₄+D₅)+ρ₀d₂γΣD(A/B) (40)

The transfer end voltage Vt^{e} is, when x₀=x₁=d₁, Vt=Vt^{e}, from the expression (38), ρ₁d₂+(Hₜ+σb)=0,

∴Vt^{e}=Va−σb(D₃+D₄+D₅)−ρ₀d₂(1−γ)ΣD(A/C) (41)

Further, the transfer voltage Vt=Vt^{f} to give the toner electric charge reversal, is from the expression (31), ρₜ=0,

∴Vtⁱ=Va−σb(D₃+D₄+D₅)−(ρ₀ε₂/α)ΣD·A (42)

and each of transfer voltage is respectively obtained.

In the toner electric charge reversal efficiency α=0, because ρ₀<0, Vt^{f}=∞, and it is found that the sign reversal of the toner electric charge does not occur. Herein, the relationship of Vtⁱ≧Vt^{e}≧Vt^{f} will be confirmed.

Vt^{e}−Vtⁱ=−ρ₀d₂ΣD(A²/BC)≧0 (43)

Vt^{f}−Vt^{e}=−ρ₀ε₂ΣD(A²/αB)≧0 (45)

(Vt^{f}−Vt^{e})/(Vt^{e}−Vtⁱ)=(B/αD₂)

=((D₁/D₂)+γ(1−α))/α (46)

From the expression (46), it is found that this ratio gives (D₁/D₂) at α=1, and is the infinity at α=0. Next, the force exerted on the toner layer will be considered. Because the force is given by F=−ρₜdψ₂/dx, by using the expression (31) and the expression (38),

F=(ρₜ/ε₂)(ρₜ(x−x₂)−(Hₜ+σb))

=(α/ε₂³(AεD)²)(αX−ε₂A)(Vt−Vt^{f})·(V+ρ₀ε₂ΣD·AX/(αX−ε₂A)) (47)

Herein,

X=(x−x2+d₂γ), V=Vt−Va+σb(D₃+D₄+D₅)

From the expression (47), it is found that F is a function of the position x and the transfer voltage Vt. Accordingly, the force exerted on the toner layer surface (x=x₂) and the lowest layer surface of the toner layer (x=x₁: the interface of the photoreceptor and the toner layer) is found.

F(x₂)=−(Bα/(ε₂AΣD)²)(Vt−Vt^{f})(Vt−Vtⁱ)

=−(Bα/(ε₂AΣD)²)(Vt−(Vt^{f}+Vtⁱ)/2)²−(Vt^{f}−Vtⁱ)²/4) (48)

F(x₂)|max=(Bα/(2ε₂AΣD)²)(Vt^{f}−Vtⁱ)²

=(ρ₀A)²/4αB (49)

The force of the toner layer surface becomes the repulsive force in the range of Vtⁱ≧Vt≧Vt^{f} and exerts on the recording transfer material side, and contributes to the transfer. It is found that this repulsive force has the local maximum value at Vt=(Vt^{f}+Vtⁱ)/2. Incidentally, the unit of the force is, because ρ₀ is (C/m³), the force per unit volume is (N/m³). On the one hand, the force exerting on the surface of the lowest layer of the toner layer is,

F(x₁)=−(Cα/(ε₂AΣD)²)(Vt−Vt^{f})(Vt−Vt^{e})

=−(Cα/(ε₂AΣD)²)(Vt−(Vt^{f}+Vt^{e})/2)²−(Vt^{f}−Vt^{e})²/4) (50)

F(x₁)|max=(Cα/(2ε₂AΣD)²)(Vt^{f}−Vt^{e})²

=(ρ₀A)²/4αC (51)

The force of the toner layer surface becomes the repulsive force in the range of Vt^{e}≦Vt≦Vt^{f} and forwards on the recording transfer material side, and it is found that this repulsive force has the local maximum value at Vt=(Vt^{f}+Vt^{e})/2. When the maximum values exerting on the surface and the lowest layer surface are compared to each other, because C≧B, naturally, the force exerting on the toner layer surface is larger.

In the present analysis, only the electrostatic force is the object of discussion, and the attractive force exerting on the interface between the photoreceptor and the toner layer, such as the mirror image force exerting on the lowest layer surface of the toner layer, that is, the interface between the photoreceptor and the toner layer, or the Van der Waals force influencing on the micro diameter toner smaller than 10 μm, is not taken up. Accordingly, at the transfer voltage Vt=Vt^{e}, the situation can be said that the force forwarding the recording medium side which is the transfer material, begins to exert on, that is, the transferring starts with respect to the toner of the lowest layer surface. Therefore, actual transfer efficiency is, specifically in the above micro toner, in the situation that the transfer efficiency can not be said to be always η=1, due to these interface attractive forces.

Accordingly, it is considered that the transfer efficiency according to the expression (39) almost linearly rises from η=0 at Vt=Vtⁱ, and at Vt=Vt^{e}, the attractive force of the interface becomes the resistance against the transferring, and the transfer efficiency changes from the linear change to the moderate saturation tendency. Then, at the transfer voltage Vt=(Vt^{f}+Vt^{e})/2 at which the electrostatic transfer force on the interface (the expression (50) and expression (51)) becomes the maximum, it shows the peak, and it is considered that, after that, in company with the rise of the transfer voltage, the electrostatic transfer force (the expression (50)) is lowered, and the transfer efficiency is lowered, and at Vt=Vt^{f}, following the reversing of the electric charge, the electrostatic transfer force becomes 0, and the transfer efficiency also becomes η=0.

Summing up the above results, when the relationship of the transfer efficiency η and the transfer voltage Vt is conceptually shown, FIG. 8 is obtained. In this connection, among Vtⁱ, Vt^{e} and Vt^{f} on the horizontal axis, the relationship of the expression (46)exists. In this relationship, when α=1, (Vt^{f}−Vt^{e})/(Vt^{e}−Vtⁱ)=(D₁/D₂) is given, and this ratio among the horizontal axis, the electric charge reversal efficiency α of the toner layer can be experimentally evaluated.

Next, the change by Vt of the extremal value x₀ given by the expression (38) will be considered. By using the expression (31) and the expression (37),

x₀=x₂+(Hₜ+σb)/ρₜ

=(d₁+d₂(1−γ))+V/(ρ₀ΣD+(αV/ε₂A)) (52)

where V=Vt−Va+σb(D₃+D₄+D₅)

Herein, because, at V→±∞, x₀=d₁(1+(ε₂/αε₁))+d₂(1+(1−α)γ/α), in the above expression (40), at Vt=Vtⁱ, V=ρ₀d₂γΣD(A/B), x₀=d₁+d₂, and in the expression (41), at Vt=Vt^{e}, V=−ρ₀d₂(1−γ)ΣD(A/C), X₀=d₁, and in the expression (42), Vt=Vt^{f}, ρ₁=0, then, the extremal value x₀ is indefinite.

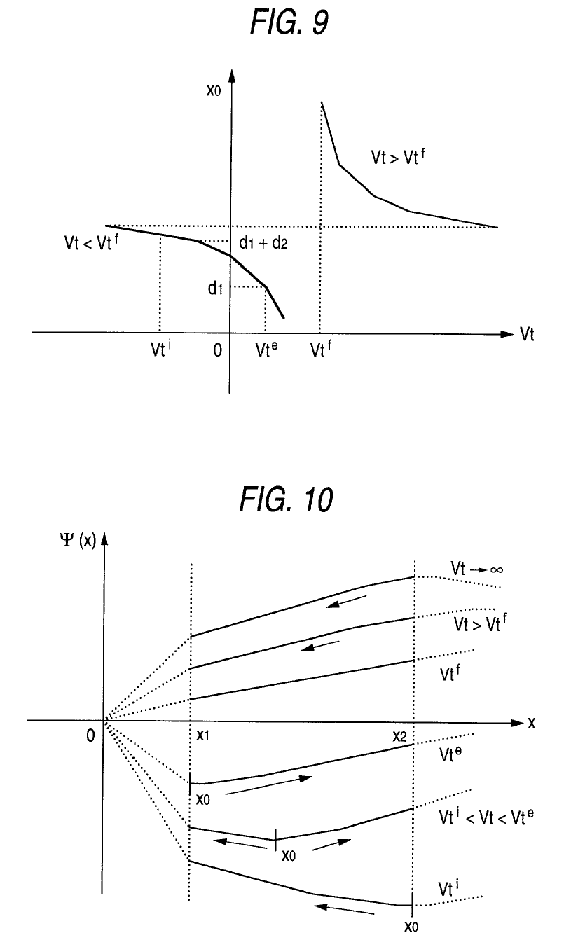

To the potential distribution ψ₂(x) of the toner layer, these relationships are conceptually given in FIG. 9 and FIG. 10. FIG. 9 is the relationship of the extremal value x₀ and V, and FIG. 10 is the potential distribution of ψ₂(x) to the position x. From FIG. 10, the potential distribution changes, at Vt<Vt^{f}, because Pρₜ<0, to a parabola which is convex to the lower side, and at Vt>Vt^{f}, because ρₜ>0, to a parabola which is convex to the upper side, and it is shown that the force exerts on the photoreceptor side ranging over all area of the toner layer.

Under these analysis, the potential difference Vₐᵢᵣ of the air gap layer can be obtained as follows, by using the expression (33) and the expression (34).

Vₐᵢᵣ=ψ₃(x₃)−ψ₂(x₂)=HₜD₃ (53).

It is found that Vₐᵢᵣ changes according to (D₃/ΣD) to the air gap layer, and at d₃=0, it becomes 0. Further, it can also be easily found that, at Hₜ=0, Vₐᵢᵣ=0. This is for the reason that the each of insertion layers at the transfer position has the different dielectric thickness Dᵢ, and further, as the initial condition, ρ₀, Va, and σb are given. By using the expression (37) and the expression (40), the condition of Vₐᵢᵣ=0 can be specified as follows.

Vₐᵢᵣ=0, Hₜ=0:

Vt=Va−σb(D₃+D₄+D₅)+(ραd₂γ+αb)ΣD(A/B)

=Vtⁱ+σbΣD(A/B) (54)

In order to realize Vₐᵢᵣ=0 under the condition on which the ideal transfer efficiency η=1, and the transfer is sufficiently conducted, under the condition of Vt^{e}≦Vt≦Vt^{f} as the transfer voltage, preferably, within the range in which the force shown in the expression (51)exerting on the interface between photoreceptor and the toner layer, shows the local maximum, that is, within Vt^{e}≦Vt≦(Vt^{f}+Vt^{e})/2, the pre-transfer charging amount σb satisfying the expression (54) is impressed onto the toner layer surface. This pre-transfer charging amount σb, in the reversal development of ρ₀<0, which is the subject of the present analysis, can be given as follows.

At Vt=Vt^{e},

Vₐᵢᵣ=0: σb=(Vt^{e}−Vtⁱ)B/(AΣD) (55)

∴σb=−ρ₀d₂(A/C)>0 (56)

At Vt=(Vt^{f}+Vt^{e})/2, V^{air}=0:

σb=((Vt^{f}+Vt^{e})/2−Vtⁱ)B/(AΣD) (57)

∴σb=−(ρ₀ε₂A)(2C−B)/(2αC)>0 (58)

At Vt=Vt^{f}, Vₐᵢᵣ=0:

σb=((Vt^{f}−Vtⁱ)B/(AΣD)

∴σb=−(ρ₀ε₂A/α)>0 (59)

The relationship of σb(:Vt^{e})≦σb(:Vt^{f}+Vt^{e}/2)≦σb (:Vt^{f}) is confirmed.

Herein, σb(: Vt^{f}) is defined to express the pre-transfer charging amount σb which gives Vₐᵢᵣ=0 at Vt=Vt^{f}. From the expression (56) and the expression (58),

σb(: Vt^{f}+Vt^{e}/2)−σb(:Vt^{e})=−(ρ₀ε₂AB/2Cα)>0 (60)

From the expression (58) and the expression (59),

Σb(:Vt^{f})−σb(:Vt^{f}+Vt^{e}/2)=−(ρ₀ε₂AB/2C)>C (61)

As described above, in order to obtain the pre-transfer charging amount σb to realize Vₐᵢᵣ=0 from the experimental results, the expression (55) and the expression (57) can be used, and when the expression (56), the expression (58), and the expression (59) are used, it is also possible to forecast the desirable pre-transfer charging amount σb in the analytical form. In the electrophotographic recording method, various kinds of sheets are used, and when the margin of the variation of above parameters such as the apparatus mounting circumferences is considered, it can be concluded that, in the reversal development of ρ₀<0, the pre-transfer charging amount σb is defined as (Vt^{e}−Vt^{f})B/(AΣD)≦σb≦(Vt^{f}−Vtⁱ)B/(AΣD) (the expression (62)), preferably, by selecting to (Vt^{e}−Vtⁱ)B/(AΣD)≦σb≦((Vt^{e}−Vt^{f})/2−Vtⁱ)B/(AΣD) (the expression (63)), Vₐᵢᵣ=0 is realized and the Paschen discharge can be avoided.

On the one hand, in the reversal development of ρ₀>0, because the above condition changes to Vt^{f}<Vt^{e}<Vtⁱ, the pre-transfer charging amount σb to realize Vₐᵢᵣ=0, is, in Vt=Vt^{e} in the expression (55), Vₐᵢᵣ=0: −σb=(Vtⁱ−Vtₑ)B/(AΣD)

∴−σb−ρ₀d₂(A/C)>0 (64)

In Vt=(Vt^{f}+Vt^{e})/2 of the expression (57), Vₐᵢᵣ=0:

−σb=(Vtⁱ−(Vt^{f}+Vt^{e})/2)B/(AΣD)

∴−σb=(ρ₀ε₂A)(2C−B)/(2αC)>0 (65)

Further, at Vt=Vt^{f}, Vₐᵢᵣ=0:

−σb=(Vtⁱ−Vt^{f})B/(AΣD)

∴−σb=(ρ₀ε₂A)/α)>0 (66)

Accordingly, in the reversal development of ρ₀>0, when

(Vtⁱ−Vt^{e})B/(AΣD)≦−σb≦(Vtⁱ−Vt^{f})B/(AΣD) (67),

and preferably,

(Vtⁱ−Vt^{e})B/(AΣD)≦−σb≦(Vtⁱ−(Vt^{e}+Vt^{f})/2)B/(AΣD) (68),

the pre-transfer charging amount σb can realize Vₐᵢᵣ=0, and can avoid the Pashen discharge. Herein, the result of the present analysis will be confirmed by numeric values. The adopted numeric values are physical qualtities as in the following table and the following description. Relating to these numeric values, Q/M=−35 C/g, ρg=1.2 g/cm³, and P=0.5 are adopted, and from the expression (26), ρ₀ is obtained, and in the expression (27), θ=1 is put, and the thickness of the toner layer 13.2 μm is given. Further, as the air gap layer, 10 μm which is forecast from the undulation of the sheet is used, and the belt material is the urethane rubber material.

TABLE 1

| | 1st | 2nd | 3rd | 4th | 5th |
|---|---|---|---|---|---|
| Area | layer | layer | layer | layer | layer |
| Material | OPC | Toner | Air | Paper | Belt |
| dᵢ (μm) | 17 | 13.2 | 10 | 80 | 630 |
| ε₁ (ε₀) | 3 | 1.7 | 1.0 | 2.5 | 11 |
| Di (μm/ε₀) | 5.67 | 7.76 | 10 | 32 | 57.27 |

V₀=−650 V,

Va=−100 V,

Vb=−400 V,

ρ₀=−21 C/m³,

D₃+D₄+D₅=99.27 (μm/ε₀),

ΣD=112.7 (μm/ε₀),

D₁+D₂/2=9.55 (μm/ε₀),

γ=0.0847,

1−y=0.9153,

A=6.33 (μm/ε₀),

B=6.33−0.658α (μm/ε₀),

C=6.33+7.10α (μm/ε₀).

(The first; α=1, σb=0, θ=1)

Vtⁱ=−435 V

Vt^{e}=1435 V,

Vt^{f}=2781 V,

(Vt^{e}+Vt^{f}/2)=2108 V,

ρₜ=−20.3+7.29×10⁻³ Vt (C/m³),

Hₜ=7.95×10⁻³Vt+3.46 (Vε₀/μm),

Vₐᵢᵣ=D₃Hₜ=7.95×10⁻²Vt+34.6 (V)

TABLE 2

| | | | | | | |
|---|---|---|---|---|---|---|
| Vt(V) | −435 | 0 | 1000 | 1435 | 2108 | 2781 |
| Vₐᵢᵣ(V) | 0 | 35 | 114 | 148 | 202 | 255 |

This is the result of the 10 μm air layer. After the transfer, the gap between the recording transfer material (sheet) and the photoreceptor is enlarged, and the sheet advances to the fixing, and the photoreceptor advances to the cleaning process. In this calculation, for example, the air gap layer potential difference 202 (V) of the voltage Vt=2108 (V) in which it is forecast that for example, the transfer efficiency becomes the maximum, is, when the gap is 100 μm, enlarged to about 1100 (V). When the Paschen discharge voltage is written as Vp, Vp=312+6.2 d₃ (μm) (the unit is [V]), and it is said that the Paschen discharge is generated at |Vₐᵢᵣ|>Vp, and in this case, the disturbance of the toner image due to the Paschen discharge is forecast.

(The second; α=1.0, σb=σb(: Vt^{e}), θ=1)

σb=14.88 (Vε₀/μm),

Vtⁱ=−1912 V,

Vt^{e}=−42 V,

vt^{f}=1304 V,

(Vt^{e}+Vt^{f}/2)=631 V,

ρₜ=−9.51+7.29×10⁻³ Vt (C/m³),

Hₜ=7.95×10^{-3,}

Vt+0.317 (Vε₀/μm),

Vₐᵢᵣ=D₃Hₜ=7.95×10⁻² Vt+3.2 (V)

TABLE 3

| | | | | | | |
|---|---|---|---|---|---|---|
| Vt(V) | −1912 | −1000 | −42 | 631 | 1304 | 2000 |
| Vₐᵢᵣ(V) | −148 | −76 | 0 | 53 | 106 | 161 |

(The third; α=1.0, σb=σb(: Vt^{e}+Vt^{f}/2), θ=1)

σb=20.02 (Vε₀/μm),

Vtⁱ=−2242 V,

Vt^{e}=−372 V,

Vt^{f}=974 V,

(Vt^{e}+Vt^{f}/2)=301 V,

ρₜ=−7.1+7.29×10⁻³ Vt (C/m³),

Hₜ=7.95×10⁻³Vt−2.38 (Vε₀/μm),

Vₐᵢᵣ=D₃Hₜ=7.95×10⁻²Vt+23.8 (V)

TABLE 4

| | | | | | | |
|---|---|---|---|---|---|---|
| Vt(V) | −2242 | −1000 | −372 | 301 | 974 | 2000 |
| Vₐᵢᵣ(V) | −201 | −103 | −53 | 0 | 53 | 134 |

As described above, the generation of the Paschen discharge can be avoided. From the same calculation, to the various cases, the effectiveness of the present analysis can be confirmed. Incidentally, the above analysis is described in the reversal development method, however, also in the normal development method, the same effectiveness can be given in the same manner. In this case, the relationship between the volume density of electric charge ρ₀ of the toner layer and the surface potential V0 of the development area is ρ₀V₀=ρ₀σ₀D₁<0, and when the organic photoreceptor (OPC) is adopted as the electrostatic recording body layer, V₀<0, and ρ₀>0. Then, taking notice of this relationship, when the area Va in which the toner is developed in the reversal development, is re-written by V₀=σ₀D₁, the relational expressions of the reversal development can be used almost as they are. However, because

ρ₀>0, Vtⁱ−Vt^{e}=ρ₀d₂ΣD(A²/BC)>0 (69)

Vt^{e}−Vt^{f}=ρ₀ε₂ΣD(A²/αC)>0 (70)

Vtⁱ−Vt_{f}=ρ₀ε₂ΣD(A²/αB)>0 (71),

and its relationship is changed to the relationship of Vt^{f}<Vt^{e}<Vtⁱ. Following this, the force F(x₁) exerting on the toner layer surface, and the force F(x₂)exerting on the interface of the toner layer and the photoreceptor, respectively become the repulsive forces within the ranges of Vt^{f}≦Vt≦Vtⁱ, and Vt^{f}≦Vt≦Vt^{e}. Accordingly, in the normal development of ρ₀>0, the pre-transfer charging amount σb is,

(Vtⁱ−Vt^{e})B/(AΣD)≦−σb≦(Vtⁱ−Vt^{f})B/(AΣD) (72),

preferably,

(Vtⁱ−Vt^{e})B/(AΣD)≦−σb≦(Vtⁱ−(Vt^{e}+Vt^{f})/2)B/(AΣD) (73),

and thereby, Vₐᵢᵣ=0 is realized, and the Paschen discharge can be avoided. It is found that these relational expressions (72) and (73) coincide with the relational expressions in the reversal development of ρ₀>0. Further, in the same manner, in the normal development of ρ₀<0, as the pre-transfer charging amount b, the relational expressions (62) and (63) are obtained.

These analysis relate to a method to obtain Vₐᵢᵣ=0, in which the pre-transfer charging amount σb is used at Vt≠0, in order to avoid the Paschen discharge under the condition Vt^{e}≦Vt≦Vt^{f}. However, the effectiveness of the present analysis is not limited to the above method, but it is also effective to obtain the maximum transfer efficiency under the condition of Vt=0, in the electrostatic method such as the electrophotographic recording, that is, in the development method using the charged toner. This is, normally, practically effective for the transfer method to realize the transfer of the toner image non-electrostatically, in the heating and fusing condition, or for the method to realize the local maximum of the transfer efficiency η by optimally selecting the pre-transfer charging amount σb at the pressure transfer. The selection of the pre-transfer charging amount σb for ρ₀≦0, can be conducted by the following method, so that each of specific potential of Vt^{e}≦Vt≦Vt^{f}, preferably, the potential of Vt^{e}≦Vt≦(Vt^{f}+Vt^{e})/2 becomes 0.

Vt=Vt^{e}=0,

σb=(CVa−σ₀d₂(1−γ)ΣD·A)/(C(D₃+D₄+D₅)) (74)

Vt=(Vt^{f}+Vt^{e})/2=0,

σb=(2αCVa−(ρ₀ε₂ΣD·A)(2C−A))/(2αC(D₃+D₄+D₅)) (75)

Vt=Vt^{f}=0.

σb=(αVa−(σ₀ε₂ΣD·A))/(α(D3+D₄+D₅)) (76)

The relationship of σb(:Vt^{e})≦σb(Vt^{f}+Vt^{e}/2)≦αb(:Vt^{f})is confirmed. Herein, αb(:Vt^{f}) expresses the pre-transfer charging amount σb to realize Vt=Vt^{f}=0.

σb(:Vt^{f}+Vt^{e}/2)−σb(:Vt^{e})=

−(ρ₀ε₂ΣD·A²)/(2Cα(D₃+D₄+D₅))>0 (77)

σb(:Vt^{f}−σb(:Vt^{f}+Vt^{e}/2)=−(ρ₀ε₂ΣD·A²)/(2Cα(D₃+D₄+D₅))>0 (78)

Accordingly, for ρ₀<0, as the pre-transfer charging amount σb, σb≦(αVa−(ρ₀ε₂ΣD·A))/(α(D3+D4 +D5)) is selected from the range of (CVa−ρ₀d₂(1−γ)ΣD·A)/(C(D₃+D₄+D₅))≦σb, preferably, when σb≦(2αCVa−(ρ₀ε₂ΣD·A)(2C−A))/(2αC(D₃+D₄+D₅)) is selected from the range of (CVa−ρ₀d₂(1−γ)ΣD·A)/(C(D₃+D₄+D₅))≦σb, the local maximum value of the transfer efficiency η can be given even under the condition of the transfer voltage Vt=0.

On the one hand, for ρ₀>0, from the relationship of the expressions (77) and (78), it is changed to σb(:Vt^{f})≦σb(Vt^{f}−Vt^{e}/2)≦σb(:Vt^{e}), and accordingly, as the pre-transfer charging amount σb, (αVa−(ρ₀ε₂ΣD·A))/(α(D3+D4+D5))≦−σb≦(CVa−σ₀d₂(1−γ)ΣD·A)/(C(D₃+D₄+D₅)) is selected, and preferably, when −σb≦(CVa−ρ₀d₂(1−γ)ΣD·A)/(C(D₃+D₄+D₅)) is selected from the range of (2αCVa−(ρ₀ε₂ΣD·A)(2C−A))/(2αC(D₃+D₄+D₅))≦σb, the local maximum value of the transfer efficiency η can be given even under the condition of the transfer voltage Vt=0.

FIG. 7 is the one dimensional 5-layer model for explaining the transfer mechanism of the electrostatic image. The origin of the coordinate is the conductor electrical ground surface of the electrostatic recording layer. On the surface of the first layer (the electrostatic recording layer), the electric charge with the surface charge density σa exists, and the second layer (the toner layer) is in the condition of the initial volume density of electric charge ρ₀, and on the toner layer surface, the surface electric charge density σb is provided as the pre-transfer charge. The transfer voltage is applied onto the surface of the fifth layer (the transfer auxiliary material) as Vt. The sign G is the electrical ground.

FIG. 8 is a conceptual view of the relationship between the transfer efficiency η and the transfer voltage Vt for ρ₀<0. Vtⁱ is the transfer start voltage, Vt^{e} is the ideal transfer end voltage, Vt^{f} is the sign reversal voltage of the toner layer electric charge density, and α is the sign reversal coefficient of the toner layer electric charge density. (Vt^{e}+Vt^{f})/2 is the voltage in which the electrostatic transfer force forwarding the recording medium layer, exerting on the lowest layer surface of the toner layer becomes the maximum. (Vt^{f}−Vt^{e})/(Vt^{e}−Vtⁱ)=((D₁/D₂)+γ(1−α))/α, and when α=1, the ratio is (D₁/D₂).

FIG. 9 is a conceptual view of the relationship between the local minimum value x₀ of the toner layer potential distribution ψ₂(x) and the transfer voltage Vt. When Vt→±∞, the local minimum value is x₀=d₁(1+(ε₂/αε₁))+d₂(1+(1−α)γ/α), and at Vt=Vtⁱ, x₀=d₁+d₂, and at Vt=Vt^{e}, x₀=d₁, and at Vt=Vt^{f}, because ρₜ=0, the extremal value x₀ is indefinite.

FIG. 10 is a conceptual view of the relationship between the toner layer potential distribution ψ₂(x)and the transfer voltage Vt. An arrow mark in the drawing shows the direction of the force exerted on the toner layer. The positive charge particle is exerted toward the lower side of the potential by the force, and the negative charge particle is exerted toward the higher side of the potential by the force. At Vt<Vt^{f}, ρₜ<0 and the force exerts toward the higher potential side, and accordingly, the direction of the exertion of the force is changed on the boundary of the local minimum value x₀. At Vt>Vt^{f}, it changes to ρₜ>0, and the force exerts onto the lower potential side, that is, the force exerts on the electrostatic recording layer.

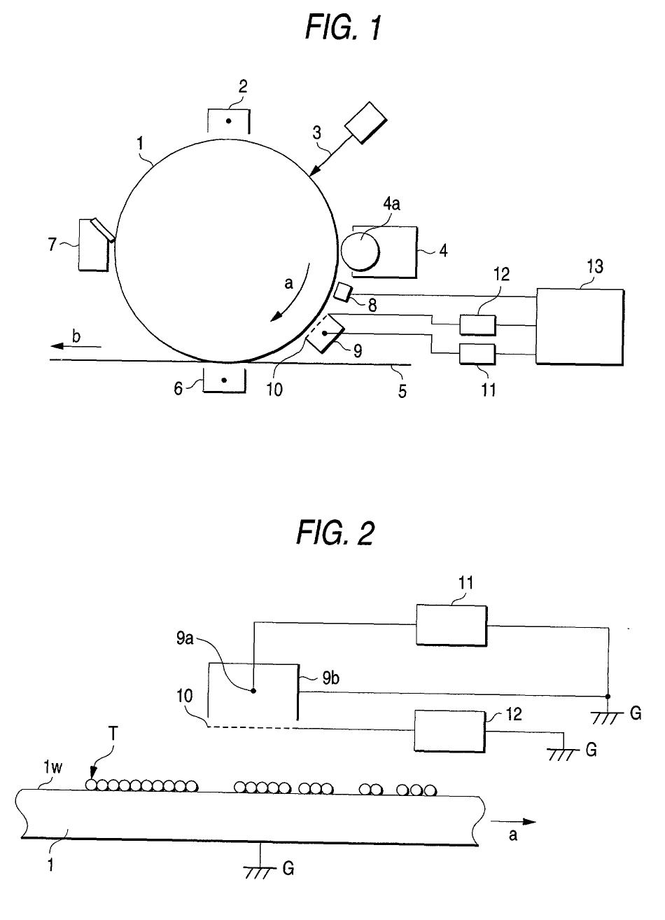

Next, by using FIG. 1-FIG. 6, the electrostatic recording apparatus according to the 7th aspect to 18th aspect of the present invention will be detailed. Incidentally, in the following explanation, the electrostatic recording apparatus FIG. 1 using so-called electrophotographic recording method by which the toner image is formed on the photoreceptor surface according to the charging process, exposure process, and development process, and the toner image is transferred onto the sheet by the following transfer process, will be described by illustrating FIG. 1.

In FIG. 1, numeral 1 is a photoreceptor drum, and is supported so that it is rotated in the arrowed direction at a predetermined speed vr. The charger 2 is arranged in opposite to the photoreceptor drum 1, and uniformly charges the photoreceptor drum 1 surface passing through in opposite to the charger 2. A laser light source 3 to image-wise expose the photoreceptor drum 1 surface forms the electrostatic latent image formed of the image portion potential and the background portion potential according to the print information signal from the higher rank apparatus (not shown).

A development apparatus 4 is arranged in such a manner that it is in opposite to the surface of the photoreceptor drum 1 on which the electrostatic latent image is formed. This development apparatus 4 makes the toner particles adhere onto the photoreceptor drum 1 by the electrostatic force of the electrostatic latent image and by the action of the development bias voltage applied onto a development magnetic roller 4a, and visualizes the image portion potential area as the toner image.

The toner image formed on the photoreceptor drum 1 is transferred onto the sheet 5 from the photoreceptor drum 1 by the electrostatic attraction action of the transfer device 6 which provides the electric charge with the opposite polarity to the toner from the rear side of the sheet 5, and is conveyed to the arrowed b direction. In this connection, the sheet 5 onto which the toner image is transferred is sent to the fixing device (not shown) after that, and the toner image is fixed on the sheet 5.

On the one hand, the toner remained on the photoreceptor drum 1 surface after the sheet 5 passes trough the transfer device 6, or the foreign matter such as sheet powders, is removed from the photoreceptor drum 1 surface by passing through a cleaner 7.

In this connection, numeral 8 is a potential sensor to detect the surface potential of the toner image formed on the photoreceptor drum, numeral 9 is a corona charger illustrated as an ion generation means for supplying the ion with a predetermined polarity toward the photoreceptor surface, numeral 10 is a grid electrode provided between the photoreceptor drum 1 surface and the corona charger 9, numeral 11 is a corona wire power source to apply the voltage onto the corona wire provided to the corona charger 9, numeral 12 is a grid electrode power source to apply the voltage onto the grid electrode 10, and numeral 13 is a control apparatus to control the impression voltage onto the corona wire and the grid electrode according to the output of the potential sensor 8.

Next, by using FIG. 2, the above corona charger 9 and the grid electrode 10 will be detailed. Incidentally, in FIG. 2, the related portion is shown plane-likely.

In FIG. 2, the power source 11 is the high voltage power source, and AC or DC may be allowable, or a case in which the AC is superimposed on the DC, may also be allowable. In FIG. 2, sign G is an electrical ground, and the corona ion is generated between the fine metallic corona wire 9a on which the high voltage is impressed, and an electrically grounded metallic case 9b surrounding the wire. According to the polarity of the high voltage power source 11, from the opening portion of the case 9b, ionized positive ion or negative charge electron, negative ion are emitted. The grid electrode 10 is formed of the metallic mesh, and controls the flow of the generated ion to the corona charger 9, and in the present embodiment, it is connected to the DC high voltage power source 12, however, a case in which the AC is superimposed on the DC, may also be allowable, or the AC high voltage may also be used according to the circumstances.

Sign T is the toner adhered onto the photoreceptor 1 surface by the development process (in the present embodiment, the toner T is the negatively charged toner), and the surface potential has the potential Vr given by the above expression (15) or (16). In this connection, numeral lw shows an area onto which the toner T is not adhered, and which is charged by the background potential, and the surface potential is lowered as the passage of time by the dark decay of the photoreceptor itself, however, because its decay amount is very small, in the present embodiment, the background portion potential is regarded as almost the initial potential (V0).

In the structures in FIG. 1 and FIG. 2, a case where the reversal development system in which the photoreceptor is negatively charged, is adopted, is illustrated, and the ion movement and conditions of the change of each potential are detailed below.

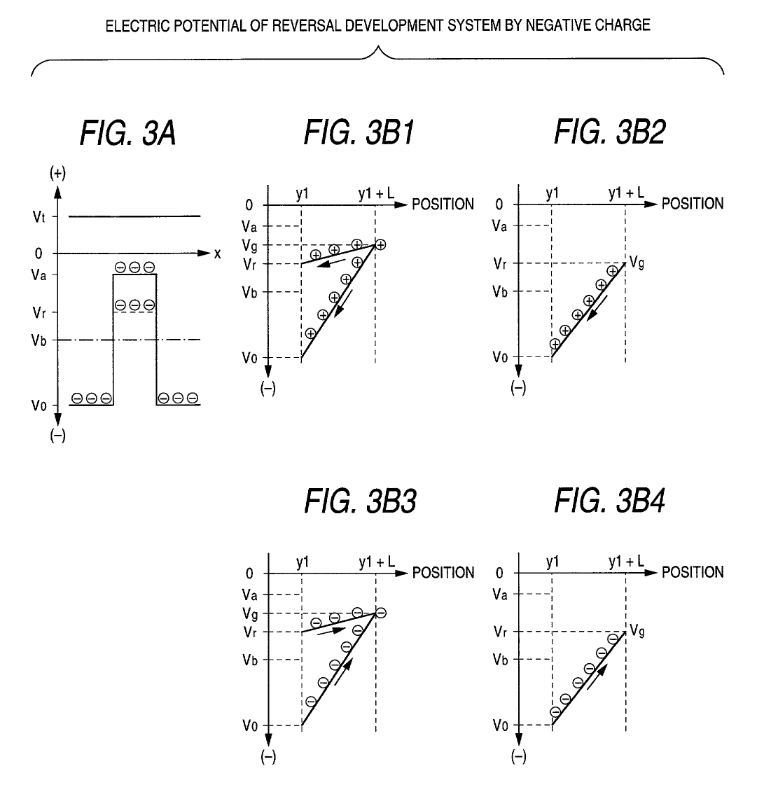

When the photoreceptor 1 is negatively charged and by the reversal development system, the toner image is obtained, the relationship among the background portion (initial charge)potential V0, the image portion (the light irradiation portion) potential Va, of the electrostatic latent image, the surface potential Vr of the toner adhered to the potential Va, and the transfer potential Vt, is as shown in FIG. 3A.

In the potential relationship of FIG. 3A, a case where, as the corona wire power source 11, the positive charge DC high voltage power source which is the reversal polarity to the image portion potential Va, is used, is shown in FIG. 3B1. The horizontal axis position y1 is a position of the photoreceptor surface, and y1+L is a position of the grid electrode. In practice, because the toner is adhered onto the image portion potential area, at the image portion potential area Va, the background potential area V0 and the surface potential Vr position of the toner image, the physical surface position is different by the thickness of the toner layer, however, when the gap between the photoreceptor and the grid electrode is L, because the difference is very small, herein, the thickness of the toner layer is neglected, and is written by y1.

Now, when the positive DC high voltage is applied onto the corona wire power source 11, the air around the corona wire is ionized, and the positively charged ions pour from the corona wire on its circumference. At that time, when the DC negative voltage Vg which is the same polarity as the image portion potential Va (Va≦0), is applied onto the grid electrode 10, as shown in FIG. 3B1, the potential difference of Vg−Vr at the portion of the toner image surface potential on the photoreceptor, and the potential difference of Vg−V0 at the portion of the background portion potential, are generated.

Herein, when the grid voltage Vg is set in the range of Vr<Vg<0, the positive ion moves toward the lower potential direction, that is, to the direction arrowed in FIG. 3B1. When the supply amount of the positive ion is sufficient, or this condition continues for a long period of time, the positive ion moderates the negative charge condition on the photoreceptor, and the toner image surface potential Vr and the background portion potential V0 coincide with the grid potential Vg, and the absolute value of both potential is lowered.

Accordingly, by the positive corona charge of the grid voltage Vg control after the development and before the transfer, the potential of the potential difference of Vg−Vr at the toner image surface potential, and the potential of the potential difference of Vg−V0 at the background potential, are discharged. As the result, the potential difference (Vt−Vr) between the positive charge transfer potential Vt and the toner image surface potential Vr is lowered to (Vt−Vg), and the potential difference (Vt−V0) between the transfer potential Vt and the background portion potential V0 is lowered to (Vt−Vg). Accordingly, the potential difference ΔVw of the gap air layer formed between the sheet and the background portion area on the photoreceptor is lowered, and does not reach the Paschen discharge condition, and the print blur of the peripheral contour portion of the toner image due to the transfer can be suppressed.

FIG. 3B3 shows a case in which, when the grid potential Vg is, in the same manner as in FIG. 3B1, in the range of Vr<Vg<0 of the same polarity as the image portion potential Va, the power source 11 is selected to the negative which is the same polarity as the image potential Va.

A condition when the negative ion or electron is emitted from the negative charge high voltage power source 11, and exists between the photoreceptor and the grid electrode, is shown in FIG. 3B3ₒ. Because the negative ion or electron forwards to the higher potential direction in reverse to the positive ion, even when the negative ion or electron exists between the photoreceptor and the grid electrode, it is accumulated on the grid electrode, and the potential of the image portion and the background portion on the photoreceptor is not directly influenced. At this time, it is not denied that the negative ion or electron jumps to the grid electrode from the toner image or the background portion on the photoreceptor, and is captured, however, on the grid voltage of about several hundreds volts, the possibility is very low, and it is considered that the discharge effect after the development and the before the transfer is very low.

However, it can be considered that the combination of FIG. 3B1 and FIG. 3B3 expresses the condition of the peak voltage of each half period, when the DC negative potential Vg of the same polarity as the image portion potential Va is applied onto the grid electrode under the condition of Vr<Vg<0, and the AC high voltage is applied onto the power source 11. That is, when FIG. 3B3 is considered, it is found that the discharge effect given in FIG. 3B1 performs the same action even under the impressed condition of the AC high voltage power source of the power source 11, however, the caution is necessary in the high speed print.

When the running speed of the photoreceptor is vr, and the effective opening width of the AC high voltage corona charger is w, it is because the AC frequency f of the AC power source should be f≧vr/w. This is for the reason why, in the frequency lower than that, while the photoreceptor travels in the corona charger area, for example, only the condition of the negative charge corona shown by FIG. 3B3 is impressed, and the positive charge corona showing the discharge effect is not impressed, and it passes through the high voltage corona charge area after the development and before the transfer.

FIG. 3B2 shows the condition when the power source 11 is the positive charge high voltage power source, and the positive ion exists in the space between the grid electrode and the photoreceptor, and as the DC grid electrode voltage, at V0<Vg≦Vr<0. specifically, it is set to V0<Vr=Vg. As is clear from the description of FIG. 3B1 and FIG. 3B3, it is found that because the positive ion is Vg=Vr, it is not attracted to the toner image surface potential portion, and the influence of the positive charge high voltage corona is not affected. On the one hand, at the background portion potential, because the relationship is V0<Vg<0, the positive ion is selectively attracted only onto the background portion potential V0 portion, and accumulated, and as the result, the absolute value is lowered from the potential V0 to Vg (=Vr). Accordingly, the toner image surface potential Vr is not changed and only the background portion potential V₀ is selectively discharged.

It is described above that, to the area of the generation of the Paschen discharge, the background portion potential V₀ of the photoreceptor relates, and that, in order to prevent the Paschen discharge, it is good that the absolute value of the potential V0 is selectively lowered, and when, by using the positive charge high voltage corona charger, the range of the DC voltage Vg of the arranged grid electrode is set to V0<Vr<Vg≦0, it is confirmed that this can be realized.

FIG. 3B4 shows the condition when the power source 11 is the negative charge high voltage power source, and the negative ion or electron exists in the space between the grid electrode and the photoreceptor, and the DC grid electrode voltage is set to V0<Vg≦Vr<0, specifically, to V0<Vr=Vg. In the same manner as in FIG. 3B3, the combination of FIG. 3B2 and FIG. 3B4 expresses a condition of the peak voltage of each half period, when the DC negative potential Vg is impressed onto the grid electrode under the condition of V0<Vr=Vg<0, and as the power source 11, the AC high voltage is used. That is, when considering about FIG. 3B4, the selective discharge effect of the background potential V0 given in FIG. 3B2 is acted equally also at the time of the AC high voltage impression of the power source 11.

As described above, FIG. 3B1 and FIG. 3B3 correspond to the whole area discharge of the surface potential Vr of the toner image and background portion potential V0 after the development and before the transfer. Further, FIG. 3B2 and FIG. 3B4 are the selective discharge of only the background portion potential V0.

For the Paschen discharge prevention, the whole area discharge is effective, however, at this time, when the discharge effect is strong, the electrostatic transfer efficiency is lowered. Accordingly, when the development efficiency is high, and the development bias potential and the toner image surface potential is Vb≈Vr, it is set to about Vg≈Vb/2, and the whole area discharge is preferable.

On the one hand, when the development efficiency is low, and Va≈Vr, it is found that Vg≈Vr is preferable, in order to maintain the transfer efficiency. That is, in the selection of the condition of FIG. 3B1 and FIG. 3B3, or the condition of the FIG. 3B2 and FIG. 3B4, it is found that this can be judged from the magnitude of the toner image surface potential Vr after the development.

From this viewpoint, as shown in FIG. 1, when the toner image surface potential Vr after the development is measured before and after the print, or always during the print, by the potential sensor 8, and according to the measurement value, the predetermined grid potential Vg is selected, and the impression voltage onto the corona wire and the grid voltage are controlled, the high quality and highly fine image can be obtained.

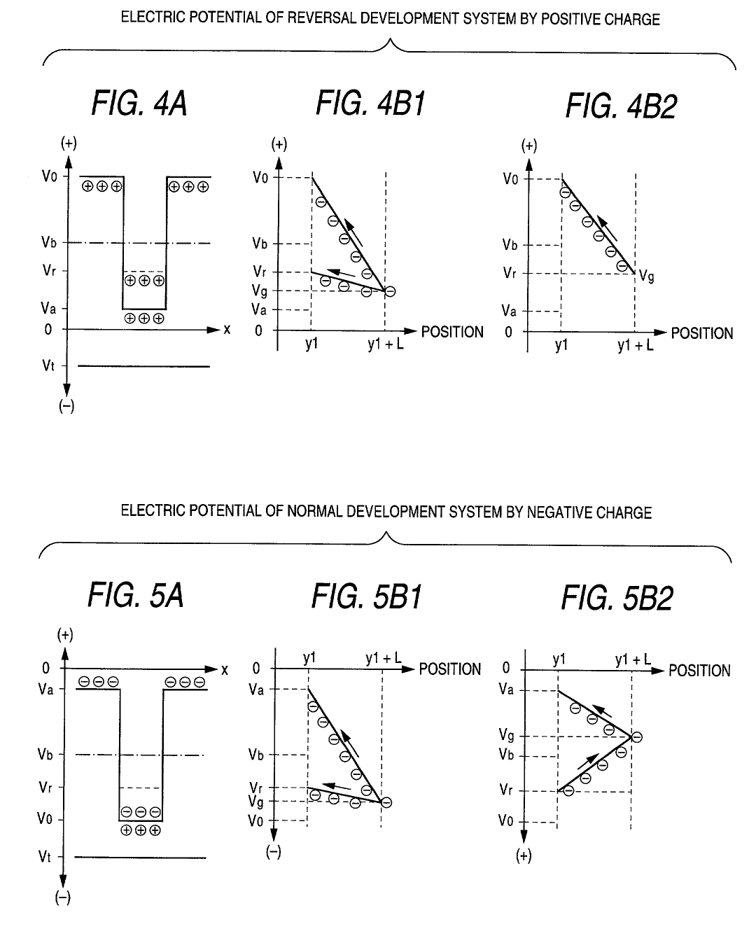

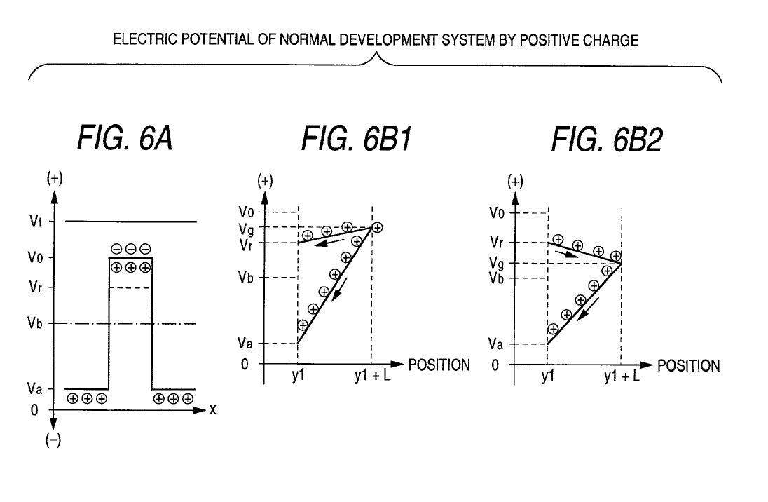

In this connection, in the above description, a case where the reversal development system by the negative charge is adopted, is described, however, the present invention is not limited to this, but when the reversal development system is adopted in the positive charging of the photoreceptor as shown in FIG. 4, the toner particle of the image portion is positively charged at this time, and corona charger supplies the negative ion with the reversal polarity to the electrostatic latent image, and the grid potential provides the same effect of action to the positive potential within the selected range. Further, as shown in FIG. 5, also for each of a case where the normal development system is adopted in the negative charging of the photoreceptor, or as shown in FIG. 6, a case where the normal development system is adopted in the positive charging of the photoreceptor, it is a matter of course that the same effect of action can be obtained.

As described above, in the relationship of each potential in the normal development system, 0≦|Va|<|Vb|<|Vr|<|V0| is realized, and the initial charge potential V0 is finally the potential of a portion onto which the toner adheres.

Further, in the normal development system, the transfer voltage Vt is the same polarity as the image portion potential V0, and because the light irradiation portion Va becomes the background portion potential, |Vt−V0|<|Vt−Va| is obtained, and it is found that the DC high voltage corona after the development and the before the transfer for the Paschen discharge prevention, is changed to the effect by the charge of the ion with the same polarity onto the light irradiation portion Va.

Further, at this time, it is found that the condition of |Vr|<|Vg|<|V0| of the grid voltage Vg is the charging condition of the whole area, and the condition of |Va|<|Vg|<|Vr| of the grid voltage Vg is the selective charge condition for the background portion potential area of the toner.

In this connection, the large difference between the AC high voltage and the DC high voltage of the corona charger power source which is the ion generation means for supplying the ion with the predetermined polarity, is that, in the AC high voltage, the half period of different polarity ineffective components are included, therefore, the DC high voltage realizes the stronger discharge or charge effect. Accordingly, as in the electrostatic recording apparatus for the high speed print, when the photoreceptor runs at the high speed, the generation ion is not sufficiently supplied onto the photoreceptor, and the discharge and charge effect is not sufficient, the DC high voltage corona charge controlled by the grid electrode is effective, and when the low speed and delicate adjustment is necessary, it is desirable that the AC high voltage corona charge which is not limited to the sinusoidal waveform controlled by the grid electrode, but various waveforms such as triangular wave are selected, is used.

As described above, according to the present invention, an electrostatic recording method and an electrostatic recording apparatus, by which the Paschen discharge which is generated in the separation process between the recording medium and the electrostatic recording body, can be prevented, and the generation of the transfer blur, or print disorder can be prevented, can be provided.

What is claimed is:

1. An electrostatic recording method comprising:
forming an electrostatic latent image having an image portion potential and a background portion potential on an electrostatic recording body;
supplying a recording agent onto the electrostatic recording body holding the electrostatic latent image to visualize an area of the image portion potential as a recording image;
applying a pre-transfer charge onto the recording image formed on the electrostatic recording body to make, the potential difference generated in an air gap between the recording medium and the recording image, smaller than the Paschen discharging potential difference; and
transferring the recording image formed on the electrostatic recording body onto a recording medium.

2. The electrostatic recording method according to claim 1, wherein the following expression is satisfied for the surface density of electric charge σ_{b} impressed upon the recording image surface in the pre-transfer charging:
(Vt^{e}−Vtⁱ)·B/(AΣD)≦σ_{b}≦(Vt^{f}−Vt¹)·B/(AΣD),
where
the initial density of the electric charge of a recording agent layer forming the recording image ρ₀<0;
the transfer start voltage is Vtⁱ;
the transfer end voltage is Vt^{e};
the electric charge reversal voltage of the transfer recording image is Vt^{f};
A=D₁+γD₂;
B=A−γαD₂;
γ=(D₁+D₂/2)/ΣD;
ΣD is a sum of the dielectric thickness related in the transfer area;
D₁ is the dielectric thickness of the electrostatic recording body;
D₂ is the dielectric thickness of the recording agent layer; and
α is an electric charge reversal efficiency of the recording image.

3. The electrostatic recording method according to claim 1, wherein the following expression is satisfied for the surface density of electric charge σ_{b} impressed upon the recording image surface in the pre-transfer charging:
(Vtⁱ−Vt^{e})·B/(AσD)≦−σ_{b}≦(Vtⁱ−Vt^{f})·B/(AΣD),
where
an initial density of electric charge of a recording agent layer forming the recording image ρ₀>0;
the transfer start voltage is Vtⁱ;
the transfer end voltage is Vt^{e};
the electric charge reversal voltage of the transfer recording image is Vt^{f};
A=D₁+γD₂;
B=A−γαD₂;
γ=(D₁+D₂/2)/ΣD; and
ΣD is a sum of the dielectric thickness related in the transfer area;
D₁ is the dielectric thickness of the electrostatic recording body;
D₂ is the dielectric thickness of the recording agent layer; and
α is an electric charge reversal efficiency of the recording image.

4. An electrostatic recording method comprising:
forming an electrostatic latent image having an image portion potential and a background portion potential on an electrostatic recording body;
supplying a recording agent onto the electrostatic recording body holding the electrostatic latent image to visualize an area of the image portion potential as a recording image;
applying the pre-transfer charging onto the recording image formed on the electrostatic recording body to make, the potential difference generated in an air gap between the recording medium and the recording image, be 0;
passing the recording medium between the electrostatic recording body and a transfer auxiliary body provided opposite to the electrostatic recording body; and
transferring the recording image formed on the electrostatic recording body onto the recording medium.

5. An electrostatic recording method according to claim 4, wherein, the following condition is satisfied:
(C·Va−ρ₀·D₂(1−γ)·ΣD·A)/(C·(D₃+D₄+D₅)≦σ_{b}≦(α·Va−(ρ₀·ε₂D·A))/(α(D₃+D₄+D₅)),
where:
an initial density of electric charge of the recording agent layer forming the recording image ρ₀<0;
the pre-transfer charging amount is σ_{b};
A=D₁+γD₂;
B=A−γαD₂;
C=D₁+D₂(γ+α(1−γ));
γ=(D₁+D₂/2)/ΣD;
ρ₀ is an initial density of electric charge of the recording agent layer;
ε₂ is a dielectric constant;
ΣD is a sum of the dielectric thickness related in the transfer area;
D₁ is the dielectric thickness of the electrostatic recording body;
D₂ is the dielectric thickness of the recording agent layer;
D₃ is the dielectric thickness of an air gap layer;
D₄ is the dielectric thickness of the recording medium;
D₅ is the dielectric thickness of the transfer auxiliary body; and
α is an electric charge reversal efficiency of the recording image.

6. The electrostatic recording method according to claim 4, wherein the following condition is satisfied:
(α·Va−(ρ₀·ε₂ΣD·A))/(α·(D₃+D₄+D₅))≦−σ_{b}≦(C·Va−ρ₀·D₂(1−γ)·ΣD·A)/(C·(D₃+D₄+D₅),
where:
an initial density of electric charge of the recording agent layer forming the recording image Σ₀<0; and
the pre-transfer charging amount is σ_{b};
A=D₁+γD₂;
B=A−γαD₂;
C=D₁+D₂(γ+α(1−γ));
γ=(D₁+D₂/2)/ΣD;
ρ₀ is an initial density of electric charge of the recording agent layer;
ε₂ is a dielectric constant;
ΣD is a sum of the dielectric thickness related in the transfer area;
D₁ is the dielectric thickness of the electrostatic recording body;
D₂ is the dielectric thickness of the recording agent layer;
D₃ is the dielectric thickness of an air gap layer;
D₄ is the dielectric thickness of the recording medium;
D₅ is the dielectric thickness of the transfer auxiliary body; and
α is an electric charge reversal efficiency of the recording image.

7. An electrostatic recording apparatus comprising:
an electrostatic latent image forming unit for forming an electrostatic latent image having an image portion potential and a background portion potential on an electrostatic recording body;
a developing unit for supplying a recording agent onto the electrostatic recording body holding the electrostatic latent image to visualize an area of the image portion potential as a recording image;
a transfer unit for transferring the recording image formed on the electrostatic recording body onto a recording medium;
an ion generation unit disposed between the developing means and the transfer section, the ion generation unit for supplying an ion with a predetermined polarity toward the electrostatic recording body; and
a grid electrode unit disposed between the surface of the electrostatic recording body and the ion generation unit, the grid electrode unit having a grid potential set to a value between the image portion potential and the background portion potential, the grid electrode unit for controlling the movement of the ion so that at least the background portion potential becomes equal to the grid potential.

8. An electrostatic recording apparatus comprising:
an electrostatic latent image forming unit for forming an electrostatic latent image having an image portion potential and a background portion potential on an electrostatic recording body;
a developing unit for supplying a recording agent onto the electrostatic recording body holding the electrostatic latent image to visualize an area of the image portion potential as a recording image;
a transfer unit for transferring the recording image formed on the electrostatic recording body onto a recording medium;
an ion generation unit disposed between the developing means and the transfer means, the ion generation unit for supplying an ion with a reverse polarity to the electrostatic latent image toward the electrostatic recording body; and
a grid electrode unit disposed between the surface of the electrostatic recording body and the ion generation unit, the grid electrode unit having a grid potential set to a value between the image portion potential and the background portion potential, the grid electrode unit for controlling the movement of the ion so that at least the background portion potential becomes equal to the grid potential and the surface potential of the recording image and the grid potential are set to satisfy the condition of 0<|Vg|≦|Vr| when the surface potential of the recording image is Vr, and the grid potential is Vg.

9. An electrostatic recording apparatus comprising:
an electrostatic latent image forming unit for forming an electrostatic latent image having the image portion potential and a background portion potential on a electrostatic recording body;
a developing unit for supplying a recording agent onto an electrostatic recording body holding the electrostatic latent image to visualize an area of the image portion potential as a recording image
a transfer unit for transferring the recording image formed on the electrostatic recording body onto a recording medium;
an ion generation unit disposed between the developing unit and the transfer unit, the ion generation unit for supplying an ion with a same polarity as the electrostatic latent image toward the electrostatic recording body; and
a grid electrode unit disposed between the surface of the electrostatic recording body and the ion generation unit, the grid electrode unit having a grid potential set to a value between the image portion potential and the background portion potential, the grid electrode unit for controlling the movement of the ion so that at least the background portion potential becomes equal to the grid potential and the surface potential of the recording image and the grid potential are set to satisfy the condition that 0<|Vg|≦|Vr| when the surface potential of the recording image is Vr, and the grid potential is Vg.

10. An electrostatic recording apparatus comprising:
an electrostatic latent image forming unit for forming an electrostatic latent image having an image portion potential and a background portion potential on an electrostatic recording body;
a developing unit for supplying a recording agent onto the electrostatic recording body holding the electrostatic latent image to visualize an area of the image portion potential as a recording image;
a transfer unit for transferring the recording image formed on the electrostatic recording body onto a recording medium;
an ion generation unit disposed between the developing unit and the transfer unit, the ion generation unit for supplying an ion with a reverse polarity to the electrostatic latent image toward the electrostatic recording body; and
a grid electrode unit disposed between the surface of the electrostatic recording body and the ion generation unit, the grid electrode unit having the grid potential set to a value between the image portion potential and the background portion potential, the grid electrode unit for controlling the-movement of the ion so that at least the background portion potential becomes equal to the grid potential and the surface potential of the recording image and the grid potential are set to satisfy the condition that |Vr|<|Vg| when the surface potential of the recording image is Vr, and the grid potential is Vg.

11. An electrostatic recording apparatus comprising:
an electrostatic latent image forming unit for forming an electrostatic latent image having an image portion potential and a background portion potential on an electrostatic recording body;
a developing unit for supplying a recording agent onto the electrostatic recording body holding the electrostatic latent image to visualize an area of the image portion potential as a recording image;
a transfer unit for transferring the recording image formed on the electrostatic recording body onto a recording medium;
an ion generation unit disposed between the developing unit and the transfer unit, the ion generation unit for supplying an ion with the same polarity as the electrostatic latent image toward the electrostatic recording body; and
a grid electrode unit disposed between the surface of the electrostatic recording body and the ion generation unit, the grid electrode unit having the grid potential set to a value between the image portion potential and the background portion potential, the grid electrode unit for controlling the movement of the ion so that at least the background portion potential becomes equal to the grid potential and the surface potential of the recording image and the grid potential are set to satisfy the condition that |Vr|<|Vg| when the surface potential of the recording image is Vr, and the grid potential is Vg.

12. The electrostatic recording apparatus according to any one of claims 7 to 11, wherein a DC voltage is applied onto the ion generation unit.

13. The electrostatic recording apparatus according to any one of claims 7 to 11, wherein an AC voltage is applied onto the ion generation unit.

14. The electrostatic recording apparatus according to any one of claims 7 to 11, wherein a voltage, in which an AC voltage is superimposed on a DC voltage, is applied onto the ion generation unit.

15. The electrostatic recording apparatus according to any one of claims 7 to 11, wherein a DC voltage is applied onto the grid electrode unit.

16. The electrostatic recording apparatus according to any one of claims 7 to 11, wherein a voltage, in which an AC voltage is superimposed on a DC voltage, or AC voltage is applied onto the grid electrode unit.

17. The electrostatic recording apparatus according to any one of claim 7 to 11, wherein the following relationship is satisfyed:
f≧v/w
where:
v is the moving speed of the electrostatic recording body;
w is the width of an iron supplying section of the ion generation unit; and
f is the AC frequency of the power source connected to the ion generation unit.

18. The electrostatic recording apparatus according to any one of claims 7 to 11 further comprising:
a detecting unit for detecting the surface potntial of the recording image formed on the electrostatic recording body; and
a controlling unit for controlling the at least one of voltage values of the ion generation unit and the grid electrode unit according to an output of the detecting unit.
